(19) United States
(12) Patent Application Publication
(10) Pub. No.: US 2004/0240312 A1
(43) Pub. Date: Dec. 2, 2004

(54) Method and device for mixing gases

(76) Inventors: Jean-Louis Gass, Saint Just Chaleyssin (FR); Ronan Cozic, Briis-Sous-Forges (FR); Georges Ponchin, Pierreuert (FR); Loic Lasnel, Chaux Ou Dombief (FR)

Correspondence Address: BURNS DOANE SWECKER & MATHIS L L P, POST OFFICE BOX 1404, ALEXANDRIA, VA, 22313-1404, US

(21) Appl. No.: 10/473,694

(22) PCT Filed: Jan. 20, 2003
(86) PCT No.: PCT/FR03/00282

(30) Foreign Application Priority Data
Feb. 1, 2002 (FR) 02 01207

(51) Int. Cl. B01F 5/00; B01F 15/02

(52) U.S. Cl. 366/152.1; 366/144; 366/160.1; 366/158.1; 366/182.1; 137/3

(57) ABSTRACT

Said device comprises a substantially tubular mixing chamber (1), a first inlet orifice for a stream (4) of the first gas at one end (2) of said chamber, a second inlet orifice (6) for a stream of the second gas, located downstream of said first orifice in the direction of flow of the stream of the first gas, means (10) for homogeneously mixing said streams of the first and second gases, said means being located downstream of said second inlet orifice, an outlet orifice (3) for the mixture, located downstream of said mixing means (10), at the other end of said chamber, and an orifice (11) for sampling said mixture of the first and second gases, said orifice being located between said mixing means (10) and said outlet means (3) for the mixture, said device furthermore including means (5, 8, 9) for sending the stream of the first gas into said chamber with a controlled flow rate and for sending the stream of the second gas into said chamber with a controlled flow rate.

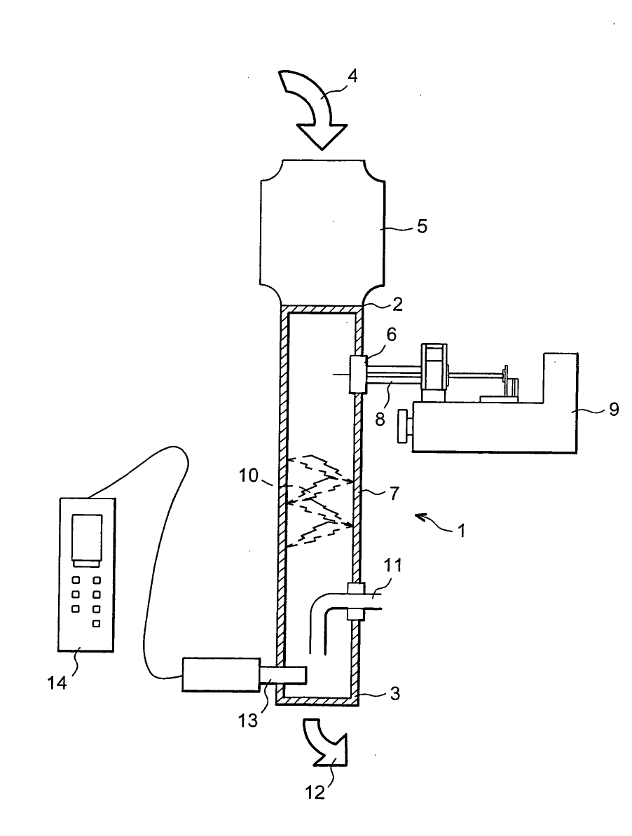

The present invention relates to a method for mixing gases.

The invention also relates to a device for mixing gases.

The invention relates in particular to a method and to a device that allow one gas to be diluted in another gas in dynamic mode, especially in very low concentrations.

The invention makes it possible to artificially recreate atmospheres that contain one particular compound with a defined concentration, such as a pollutant, and one application of the invention, among others, is in the calibration of gas sensors, the calibration of gas concentration meters, involving the plotting of calibration curves, quantification on the basis of preconcentration systems, etc.

The technical field of the invention may be defined as that of the mixing of gases and, more particularly, that of diluting one gas in another, such as air.

Gas diluting devices may be put into two categories: firstly, static or closed systems and, secondly, dynamic systems.

In static or closed systems, the products, in known amount, are generally vaporized in a glass flask, also of known volume.

This type of system gives rise to the problem of a loss of product in the case of certain compounds, this being due to adsorption on the walls of the system, which is particularly sensitive to low concentrations.

In dynamic systems, use is made of a permeation membrane through which the pollutant gas molecules pass.

These devices have the drawback of relying on statistical considerations and are generally quite difficult to implement.

There is therefore a need for a method and a device for mixing one gas in another gas, that does not have the drawbacks, limitations, shortcomings and disadvantages of the devices and methods of the prior art.

There is also a need for a method and a device for mixing one gas in another gas that makes it possible to obtain a mixture in which the respective proportions of each of the gases are defined very precisely, even with very low concentrations of one of the gases.

This method and this device must furthermore be simple to implement, and must operate in a completely reproducible manner, with high reliability and great steadiness, whatever the gases involved.

The aim of the present invention is therefore to provide a method and a device that satisfy, among others, these needs and that meet these requirements.

The aim of the present invention is also to provide a method and a device for mixing gases that solve the problems of the methods and devices of the prior art, whether these be methods and devices of the static type or methods and devices of the dynamic type.

This aim and also others are achieved, in accordance with the invention, by a method of mixing, in dynamic mode, a second gas in a first gas, in which a stream of the second gas is introduced into a stream of the first gas, said streams of the first and second gases having controlled flow rates, and said streams of the first and second gases are mixed so as to obtain a homogeneous mixture of the two gases that has a defined concentration of the second gas.

Advantageously, said first gas is chosen from air, nitrogen, argon, helium and mixtures thereof. The preferred gas is air.

Advantageously, said second gas results from the vaporization of a liquid compound (under standard temperature and pressure conditions), preferably a compound selected from liquid organic compounds and mixtures thereof.

Advantageously, said second gas is a compound selected from compounds polluting the atmospheric air and mixtures thereof. This compound may, under standard conditions, be in the liquid state or in the gaseous state.

These polluting compounds are generally selected from volatile organic compounds, for example alcohols such as n-butanol or the like.

Advantageously, according to the invention, a fraction of the homogeneous mixture of the two gases is sampled and sent into a meter and/or detector and/or concentration meter.

The method according to the invention makes it possible to artificially recreate a homogeneous gas mixture such as, for example, a polluted atmosphere, in dynamic mode.

The method according to the invention and the device, which also forms the subject matter of the present invention, because they operate in dynamic mode, fundamentally offer the advantages associated with the methods and instruments operating according to that principle, namely, above all, the fact that the problems associated with product being deposited on the walls are limited. However, the method and the device according to the invention, although they offer all the advantages of dynamic systems, do not, however, have their drawbacks. This is because they do not rely on statistical considerations and, especially because of the absence of a permeation membrane, they are simple, reliable and easy to implement, and ensure that homogeneous mixtures are prepared with precise concentrations, reproducibly and with great stability.

According to the invention, the flow rate of the first gas, such as air, and of the second gas are both controlled. It is thus very easy to obtain, with very great reliability, a homogeneous gas mixture, and even to do so for very low concentrations of the second gas in the first gas. Knowing the two flow rates, of the first and second gases, extremely precisely makes it possible to calculate, with great precision, the theoretical concentration of the second gas in the first gas, for example the concentration of the pollutant or pollutants in the air. It is possible, according to the invention, to regulate or adjust the flow rate of each of the gases with great precision, so as to obtain homogeneous mixtures having all possible concentrations and, in particular, the concentration range of the desired field of application. These concentrations are each time obtained with great precision in the final homogeneous mixture.

The invention also relates to a device for mixing, in dynamic mode, a second gas in a first gas, said device comprising a substantially tubular mixing chamber, a first inlet orifice for a stream of the first gas at one end of said chamber, a second inlet orifice for a stream of the second gas, located downstream of said first orifice in the direction of flow of the stream of the first gas, means for homogeneously mixing said streams of the first and second gases, said means being located downstream of said second inlet orifice, an outlet orifice for the mixture, located downstream of said mixing means, at the other end of said chamber, and an orifice for sampling said mixture of the first and second gases, said orifice being located between said mixing means and said outlet means for the mixture, said device furthermore including means for sending the stream of the first gas into said chamber with a controlled flow rate and means for sending the stream of the second gas into said chamber with a controlled flow rate.

The advantages of the device according to the invention have already been indicated in the foregoing description of the method, but it may be added that the device according to the invention is simple, reliable and uses only components that already exist commercially and are easily available.

The invention will now be described in detail in the following description, given by way of non-limiting illustration, with reference to the appended drawing in which:

the single figure is a schematic sectional view of a device according to the invention.

The single figure shows a device according to the invention, which comprises a mixing chamber (1), generally of approximately tubular shape, with a first end (2) and a second end (3).

The chamber, within which firstly a gas (4), such as air, flows and then the mixture of the two gases flows, is for example made of a metal, such as stainless steel, and must be able to be heated to a high enough temperature, for example 200° C., in order to be able to desorb the product(s) that have built up on the walls, if this is necessary. For this purpose, the chamber is generally provided with heating means (not shown) that may, for example, consist of a resistance heating element wound around the tubular chamber (1).

The first end (2) of the tubular chamber, or upper end in the present case, forms an inlet orifice for a stream (4) of the first gas. This first gas is, for example, air and is sent into the column via a fan (5). It is quite obvious that the fan (5) may be replaced with any suitable device for sending the stream of the first gas into said chamber with a controlled flow rate. As an example of a device that can be used for providing a controlled and steady stream of the first gas, such as air, in the chamber, mention may thus be made of a container, such as a bottle, of the compressed first gas, such as artificial air, that is connected to the inlet orifice via a flowmeter.

According to the invention, the flow rate of the first gas, such as air, may be precisely adjusted and controlled at the outlet end, or lower end, of the chamber by a device such as an anemometer probe.

Into the stream of the first gas, blown by the fan (5) and flowing in the tubular chamber (1), is injected a stream of a second gas via an inlet orifice (6) located on the side wall (7) of the chamber, downstream of, or below, the upper end (2) forming the inlet orifice for the stream of the first gas.

The second gas is in fact generally formed by the vapor of a product initially in the liquid state.

This product is injected by means of a suitable device that constitutes the means according to the invention for sending or injecting the stream of the second gas into the chamber with a controlled flow rate.

This device is, in the single figure, shown in the form of a syringe (8) provided with a precision syringe plunger (9) of the type used in the medical field, for example for dialysis.

However, in general, any system allowing controlled injection with a sufficiently low flow rate is suitable and can be fitted to the device of the invention. Thus, the means for sending the stream of the second gas into the chamber with a controlled flow rate could, for example, be formed by an inkjet printer cartridge filled with the desired product.

The product, initially in the liquid state, is generally an organic compound selected from volatile organic compounds or a mixture of the latter.

This product is generally a product that may be termed a “pollutant”, especially an atmospheric air pollutant, generally selected from volatile organic compounds or a mixture of the latter. If the product injected is a mixture of several compounds, these are in known fixed concentrations.

The liquid product, for example placed inside the syringe (8), is injected with a controlled flow rate, of the order of 1 nl/min, for example into a stream of the first gas, such as air, which also has a known flow rate. The flow rate of the first gas, such as air, may for example be of the order of m³/min and is very substantially greater than that of the injected product, in such a way that the saturated vapor pressure of the injected product is never reached and the product immediately vaporizes on leaving the syringe, in contact with the gas, such as air. Because the flow rate of the stream of the first gas is largely in majority over that of the second gas, the expression “dilution of the second gas in the first gas” may be used.

The term “largely in majority” is generally understood to mean that the flow rate of the first gas is from 10⁶ to 10¹² times greater than that of the second gas.

Provided downstream of the point of injection of the stream of the second gas are means (10) for mixing the gas streams in order to obtain a homogeneous mixture of these first and second gases, for example air and pollutant, before the sampling outlet.

In the single figure, the mixing means (10) consist of one or more static mixers, such as packing rings, for example the stainless steel RAFLUX® packing rings sold by Rauschert®, but other types of mixers may be envisioned, for example one or more dynamic mixers, such as one or more fans.

Provided downstream of the one or more mixers, for example the one or more static mixers, is a sampling orifice (11) located, in the single figure, on the side wall (7) of the chamber in order to sample, continuously or intermittently, a defined volume of the homogeneous gas mixture.

The orifice is provided with a stainless steel tube bent into a right angle toward the outlet of the device located at the end of the tubular chamber (3); the orifice has for example a diameter of about 3.2 mm (⅛ of an inch). This homogeneous gas mixture contains an extremely precise concentration of the second gas in the first gas, for example one or more pollutants in the air.

The device according to the invention makes it possible to prepare mixtures with a wide concentration range. Thus, it is possible to vary the concentrations of the second gas in the first gas, for example one or more pollutants in the air, within a range from 1 ppmv (10⁻⁶) down to 1 pptv (10⁻¹²), and to do so always with perfect stability and very great reproducibility.

The remainder (12) of the stream of the homogeneous gas mixture is discharged via a discharge orifice located at the end of the tubular chamber (3), in this case at the lower end.

Near this outlet orifice—in fact at the center of the section of the tubular chamber and slightly downstream of the lower end of the latter—the flow rate of the gas stream which is in fact essentially formed by the first gas, such as air, is measured by suitable measuring means, such as an anemometer probe (13) connected to a display device (14) of the TESTO 435® type. By measuring the output flow rate, preferably continuously, it is possible to adjust precisely, and at any instant, the flow rate of the stream of the first gas entering the chamber.

The sampling orifice is connected, for example, to a gas concentration meter (not shown) (i.e. one for measuring the concentration of the second gas in the first gas, namely, for example, of the pollutant or pollutants in air), to a gas sensor or to a preconcentration instrument, because the gas mixture leaving the sampling orifice has an extremely precise concentration of the second gas (for example of pollutant) and because it is possible to vary this concentration easily and precisely over a wide range. It is possible to improve the calibration of this gas concentration meter very precisely, even if the concentrations involved are very low. Thus, the device according to the invention also makes it possible to check the performance characteristics claimed by the manufacturers of these instruments.

The device according to the invention may be connected directly, or via a preconcentration system, to an instrument formed by the coupling of a microchromatograph to a mass spectrometer (μGC/MS).

The invention will now be described in relation to the following examples, these being given as non-limiting illustrations.

### EXAMPLE 1

This example employed a device very similar to that illustrated in the single figure, in which the instruments used were the following:

syringe plunger: supplied by Harvard Apparatus;

syringe (volume: 10 ml): supplied by Harvard Apparatus; and

fan: this was an extractor fan for ducting, supplied by S & P. The system was configured in such a way that the delivered flow rate could be adjusted between 10 and 70 m³/h approximately; and

air speed indicator: TESTO 435® model, fitted with an anemometer probe.

The first results were obtained using, as pollutant, n-butanol (density: 0.81 g/cm³; molar mass: 74.12 g/mol).

The injection flow rates obtained with the equipment described above were of the order of a few μl/min.

For example, with an injection flow rate set at 11 μ/min, the amount of n-butanol injected was therefore:

$$11 µ1 / min \times \frac{1 ml}{1000 µ 1} \times 0.81 g \text{/} ml = 9 mg \text{/} min .$$

This injected mass represented a volume of vapor at 20° C. and at atmosphere pressure of:

$$\frac{24000 ml \text{/} mol \times 9 \times {10}^{3} g \text{/} min}{74.12 g \text{/} mol} = 2885 µ 1 \text{/} min$$

i.e. 1.7×10⁻⁴ m³/h.

The air flow rate was constant and set at 19 m³/h; the theoretical n-butanol concentration at the outlet was therefore:

$$\frac{1.7 \times {10}^{- 4} {m}^{3} / h}{19 {m}^{3} / h} \times {10}^{6} = 9 p p m V .$$

If the flow rate of the injected product were to be increased to 20 μl/min, with the air flow rate remaining unchanged, the concentration would then be 17 ppmv.

The change in the n-butanol concentration was monitored in line, using μGC/MS coupling and without passing via a preliminary accumulation system. The pollutant concentration was a function of the area of the chromatograph peak, obtained by the microcatharometer detector making up the coupling. This instrument made it possible to carry out an analysis approximately every 2 minutes, and various curves of variation were thus able to be plotted in the case of n-butanol.

This example demonstrates the advantages that are in general obtained with the device and the method of the invention compared with the devices and methods of the prior art. These advantages are in particular the possibility of varying the concentration of the pollutant studied, by changing the injection flow rate, the new mixture then becoming steady in barely a few minutes (for example 5 minutes).

1. A method of mixing, in dynamic mode, a second gas in a first gas, in which a stream of the second gas is introduced into a stream of the first gas, said streams of gases having controlled flow rates, and said streams of the first and second gases are mixed so as to obtain a homogeneous mixture of the two gases that has a defined concentration of the second gas.

2. The method as claimed in claim 1, in which said first gas is chosen from air, nitrogen, argon, helium and mixtures thereof.

3. The method as claimed in claim 1, in which said second gas results from the vaporization of a liquid compound, preferably selected from vapors of liquid organic compounds and mixtures thereof.

4. The method as claimed in claim 1, in which said second gas consists of a compound selected from compounds polluting the atmospheric air and mixtures thereof.

5. The method as claimed in claim 4, in which said polluting compounds are selected from volatile organic compounds.

6. The method as claimed in claim 1, in which the flow rate of the first gas is largely in majority over the flow rate of the second gas.

7. The method as claimed in claim 6, in which the flow rate of the first gas is from 10⁶ to 10¹² times greater than that of the second gas.

8. The method as claimed in claim 1, in which a fraction of the homogeneous mixture of the two gases is sampled and sent into a meter and/or detector and/or concentration meter.

9. A device for mixing, in dynamic mode, a second gas in a first gas, said device comprising a substantially tubular mixing chamber (1), a first inlet orifice for a stream (4) of the first gas at one end (2) of said chamber, a second inlet orifice (6) for a stream of the second gas, located downstream of said first orifice in the direction of flow of the stream of the first gas, means (10) for homogeneously mixing said streams of the first and second gases, said means being located downstream of said second inlet orifice, an outlet orifice (3) for the mixture, located downstream of said mixing means (10), at the other end of said chamber, and an orifice (11) for sampling said mixture of the first and second gases, said orifice being located between said mixing means (10) and said outlet means (3) for the mixture, said device furthermore including means (5, 8, 9) for sending the stream of the first gas into said chamber with a controlled flow rate and for sending the stream of the second gas into said chamber with a controlled flow rate.

10. The device as claimed in claim 9, in which said means for mixing said streams of the first and second gases are formed by one or more static mixers.

11. The device as claimed in claim 9, in which said means for mixing said streams of the first and second gases are formed by one or more dynamic mixers, such as one or more fans.

12. The device as claimed in claim 9, in which said means for sending the stream of the first gas into said chamber with a controlled flow rate are formed by a container for the compressed first gas, and connected to said first inlet orifice via a flow meter, or by a fan.

13. The device as claimed in claim 9, in which said means for sending the stream of the second gas into said chamber with a controlled flow rate are formed by a syringe fitted with a precision syringe plunger.

14. The device as claimed in claim 9, in which said means for sending the stream of the second gas into said chamber with a controlled flow rate are formed by an inkjet printer cartridge.

15. The device as claimed in claim 9, in which the mixing chamber is provided with heating means.

16. The device as claimed in claim 9, in which the sampling orifice is connected to a gas concentration meter, to a preconcentration instrument or to a gas sensor.

17. The device as claimed in claim 16, in which the sampling orifice is connected directly, or via a preconcentration system, to an instrument formed by the coupling of a microchromatograph and a mass spectrometer.
